(19) United States
(12) Patent Application Publication
(10) Pub. No.: US 2014/0342254 A1
(43) Pub. Date: Nov. 20, 2014

(54) Photo-catalytic Systems for Production of Hydrogen

(71) Applicant: Sunpower Technologies LLC, San Marcos, CA (US)

(72) Inventors: Travis Jennings, San Diego, CA (US); Daniel Landry, Redondo Beach, CA (US)

(73) Assignee: Sunpower Technologies LLC, San Marcos, CA (US)

(21) Appl. No.: 13/897,054

(22) Filed: May 17, 2013

(51) Int. Cl. C01B 3/04

(52) U.S. Cl. CPC C01B 3/042; B82Y 99/00
USPC 429/416; 204/157.5; 422/162; 977/773

(57) ABSTRACT

A system for splitting water and producing hydrogen for later use as an energy source may include the use of a photoactive material including PCCN and plasmonic nanoparticles. A method for producing the PCCN may include a semiconductor nanocrystal synthesis and an exchange of organic capping agents with inorganic capping agents. The PCCN may be deposited between the plasmonic nanoparticles and may act as photocatalysts for redox reactions. The photoactive material may be used in presence of water and sunlight to split water into hydrogen and oxygen. Production of charge carriers may be triggered by photo-excitation and enhanced by the rapid electron resonance from localized surface plasmon resonance of plasmonic nanoparticles. By combining different semiconductor materials for PCCN and plasmonic nanoparticles and by changing their shapes and sizes, band gaps may be tuned to expand the range of wavelengths of sunlight usable by the photoactive material. The system may include elements for collecting, transferring, and storing hydrogen and oxygen, for subsequent transformation into electrical energy.

### CROSS-REFERENCE TO RELATED APPLICATIONS

The disclosure here described is related to U.S. patent Ser. No. 13/722,355, filed Dec. 20, 2012, entitled “Photo-catalytic Systems for Production of Hydrogen,” and U.S. patent application Ser. No. 13/837,412, filed Mar. 15, 2013, entitled “Method for Increasing Efficiency of Semiconductor Photocatalysts,” all of which are incorporated herein by reference in their entirety.

### BACKGROUND

1. Field of the Disclosure

The present disclosure relates generally to photocatalysis, and more specifically to a hydrogen generation system in which solar energy is used for the photocatalytic decomposition of water and production of hydrogen employing plasmonic nanoparticles and photocatalysts.

2. Background Information

Photoactive materials used for water splitting require a strong UV/visible light absorption, high chemical stability in the dark and under illumination, suitable band edge alignment to enable redox reactions, efficient charge transport in the semiconductors, and low overpotentials for redox reactions.

TiO₂ is by far the most widely investigated material due to its ready availability, low cost, lack of toxicity, and photostability. However, with the large band gap of 3.2 eV of TiO₂, only a small UV fraction (about 2-3% of the solar spectrum) may be utilized. Significant research effort is aimed at sensitization of TiO₂ by shifting the optical absorption towards the visible part of the spectrum via doping. These attempts, however, have met with limited success.

Methods for fabricating photoactive materials from semiconductor nanoparticles for photocatalytic reactions also include the use of colloidal nanoparticles with organic, volatile ligands, which have insulating characteristics that may prevent a good separation of charge carriers for use in redox reactions, reducing light harvesting and energy conversion efficiencies.

Efforts to produce photocatalysts operating efficiently under visible light have led to a number of plasmonic photocatalysts, in which noble metal nanoparticles are deposited on the surface of polar semiconductor or insulator particles. In the metal-semiconductor composite photocatalysts, the noble metal nanoparticles act as a major component for harvesting visible light due to their surface plasmon resonance, while the metal-semiconductor interface efficiently separates the photogenerated electrons and holes. However, corrosion or dissolution of noble metal particles in the course of a photocatalytic reaction is very likely to limit the practical application of such systems.

It would, therefore, be desirable to improve existing methods for producing photoactive materials to be used in water splitting for hydrogen generation.

### SUMMARY

According to various embodiments of the present disclosure, a system for splitting water and producing hydrogen by using a photoactive material including photocatalytic capped colloidal nanocrystals (PCCN) and plasmonic nanoparticles is disclosed. The photoactive material may be employed in the presence of sunlight and water to initiate redox reactions that may split water into hydrogen and oxygen.

A method for producing PCCN may include semiconductor nanocrystals synthesis and substituting organic capping agents with inorganic capping agents. The morphologies of semiconductor nanocrystals may include nanocrystals, nanorods, nanoplates, nanowires, dumbbell-like nanoparticles, and dendritic nanomaterials, among others. Each morphology may include an additional variety of shapes such as spheres, cubes, tetrahedra (tetrapods), among others. Varying sizes and shapes of PCCN may assist in tuning band gaps for absorbing different wavelengths of light.

A preparation of plasmonic nanoparticles may be performed separately from the formation of PCCN, and may include different methods known in the art, varying according to the different materials and desired shapes of noble metal nanoparticles to be used, reaction times, temperatures, and other factors. Nanoparticles of noble metals, such as Ag, Au, and Pt, may be used because noble metal nanoparticles are capable of absorbing visible light due to their localized surface plasmon resonance (LSPR), which may be tuned by varying their size, shape, and surrounding of the noble metal nanoparticles. Furthermore, noble metal nanoparticles may also work as an electron trap and active reaction sites, which may be beneficial in the use water splitting. Plasmonic nanoparticles may include any suitable shape, such as spherical (nanospheres), cubic (nanocubes), or wires (nanowires), among others.

After the preparation of plasmonic nanoparticles, a deposition of PCCN between plasmonic nanoparticles may take place upon suitable substrates. After both PCCN and plasmonic nanoparticles have been deposited on the substrate, a thermal treatment may be performed.

When light makes contact with the plasmonic nanoparticles, oscillations of free electrons may occur as a consequence of the formation of a dipole moment in the plasmonic nanoparticles due to action of energy from electromagnetic waves of incident light, leading to LSPR. Additionally, strong electric fields may be created with LSPR. Electric fields of adjacent plasmonic nanoparticles may interact with each other to facilitate charge separation for accelerating redox reactions. The photoactive material may be submerged in water within a reaction vessel so that a water splitting process may take place. Production of charge carriers may be triggered by photo-excitation and enhanced by the rapid electron resonance from LSPR. When electrons are in conduction band of PCCN, they may reduce hydrogen molecules from water, while oxygen molecules may be oxidized by holes left behind in the valence band of the plasmonic nanoparticles.

The structure of PCCN may speed up redox reactions by quickly transferring charge carriers sent by plasmonic nanoparticles to water. In addition, there may be a higher production of electrons and holes being used in redox reactions, since PCCN within the photoactive material may be designed to separate holes and electrons immediately upon the accelerated formation by plasmonic nanoparticles triggered by LSPR, thus reducing the probability of electrons and holes recombining. Consequently, the redox reaction and water splitting process may occur at a faster and more efficient rate. Additionally, high surface area of PCCN may enhance efficiency of light absorption and of charge carrier dynamics.

A water splitting system employing the water splitting process, may include elements for providing water into the reaction vessel (e.g., a device including a pump, a regulator, a blower, or any combination thereof) and elements for collecting (e.g., a device including a separator, a membrane, a filter, or any combination thereof) the hydrogen and oxygen gases produced.

Additionally, an energy generation system including the water splitting system, may include storage of hydrogen and oxygen gases in different containers, to be later used as a carbon neutral fuel source. In some cases, the hydrogen and oxygen gases produced may be converted to water using a secondary device, for example, an energy conversion device such as a fuel cell. An energy conversion device, in some embodiments, may be used to provide at least a portion of the energy required to operate an automobile, a house, a village, a cooling device (e.g., a refrigerator), or any other electrically driven applications.

In one embodiment, a method for water splitting comprises forming photocatalytic capped colloidal nanocrystals, wherein each photocatalytic capped colloidal nanocrystal includes a first semiconductor nanocrystal capped with a first inorganic capping agent; forming plasmonic nanoparticles, wherein the plasmonic nanoparticles include noble metal nanoparticles; depositing the formed plasmonic nanoparticles onto a substrate; depositing the formed photocatalytic capped colloidal nanocrystals on the substrate between the plasmonic nanoparticles, wherein each photocatalytic capped colloidal nanocrystal is deposited between at least two plasmonic nanoparticles; thermally treating the substrate, the photocatalytic capped colloidal nanocrystals, and the plasmonic nanoparticles; absorbing light with a frequency equal to or greater than a frequency of electrons oscillating against the restoring force of positive nuclei within the plasmonic nanoparticles to cause localized surface plasmon resonance, whereby the localized surface plasmon resonance creates an electric field between two adjacent plasmonic nanoparticles; absorbing irradiated light with an energy equal to or greater than the band gap of the photocatalytic capped colloidal nanocrystals that causes electrons of the photocatalytic capped colloidal nanocrystals to migrate from the valance band of the photocatalytic capped colloidal nanocrystals into the conduction band of the photocatalytic capped colloidal nanocrystals for use in a reduction reaction, wherein the electric field prevents the electrons from recombining into the valence band of the photocatalytic capped colloidal nanocrystals; passing water through the reaction vessel so that the water reacts with the photocatalytic capped colloidal nanocrystals and forms hydrogen gas and oxygen gas, wherein the charge carriers in the conduction band reduce hydrogen molecules from the water and holes in the valence band of the plasmonic nanoparticles oxidize oxygen molecules from the water; and collecting the hydrogen gas and the oxygen gas in a reservoir that includes a hydrogen permeable membrane and an oxygen permeable membrane.

In another embodiment, a water splitting system comprises a photoactive material comprising a substrate; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles; a reaction vessel housing the photoactive material and configured to receive water through a nozzle and facilitate a water splitting reaction when the water reacts with the photocatalytic capped colloidal nanocrystals, wherein the reaction occurs when the photocatalytic capped colloidal nanocrystals and plasmonic nanoparticles absorb irradiated light; and a collector connected to the reaction vessel and comprising a reservoir that includes a hydrogen permeable membrane and an oxygen permeable membrane for collecting hydrogen gas and oxygen gas.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 is a flow diagram of a process for producing a photoactive material including photocatalytic capped colloidal nanocrystals (PCCN) and plasmonic nanoparticles, according to an exemplary embodiment.

FIG. 2A illustrates plasmonic nanoparticles exhibiting an edge-to-edge nanojunction, and FIG. 2B illustrates plasmonic nanoparticles exhibiting a face-to-face nanojunction, according to an exemplary embodiment.

FIG. 3A illustrates a PCCN positioned between plasmonic nanoparticles in the edge-to-edge nanojunction, and FIG. 3B illustrates a PCCN positioned between plasmonic nanoparticles in the face-to-face nanojunction, according to an exemplary embodiment.

FIG. 4 illustrates localized surface plasmon resonance (LSPR) occurring when the photoactive material reacts to light, according to an exemplary embodiment.

FIG. 5 illustrates a water splitting process that may occur when the photoactive material is submerged in water and makes contact with incident light, according to an exemplary embodiment.

FIG. 6A illustrates light contacting plasmonic nanoparticles to excite electrons into the valence band of the plasmonic nanoparticles into the conduction band of the PCCN as part of the charge separation process that may occur during water splitting, and FIG. 6B illustrates electrons reducing hydrogen from water, according to an exemplary embodiment.

FIG. 7 illustrates a water splitting system employing water splitting process, according to an exemplary embodiment.

FIG. 8 illustrates an energy generation system that may be used to produce and store hydrogen and oxygen gases for generating electricity, according to an exemplary embodiment.

FIG. 9 illustrates a hydrogen fuel cell that may be used for mixing hydrogen and oxygen gases for the production of electricity and water, according to an exemplary embodiment.

FIG. 10 illustrates a PCCN in spherical shape, according to an exemplary embodiment.

FIG. 11 illustrates a PCCN in rod shape, according to an exemplary embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used herein, the following terms may have the following definitions:

“Semiconductor nanocrystals” refers to particles sized between about 1 and about 100 nanometers made of semiconducting materials.

“Valence band” refers to an outermost electron shell of atoms in semiconductor or metal nanoparticles, in which electrons may be too tightly bound to an atom to carry electric current.

“Conduction band” refers to a band of orbitals that are high in energy and generally empty.

“Band gap” refers to an energy difference between a valence band and a conduction band within semiconductor or metal nanoparticles.

“Inorganic capping agent” refers to semiconductor particles excluding organic materials and which may cap semiconductor nanocrystals.

“Organic capping agent” refers to materials excluding inorganic substances, which may assist in a suspension and/or solubility of a semiconductor nanocrystal in solvents.

“Photoactive material” refers to a substance capable of performing catalytic reactions in response to light.

“Localized surface plasmon resonance”, or LSPR, refers to a phenomenon in which conducting electrons on noble metal semiconductor nanoparticles undergo a collective oscillation induced by an oscillating electric field of incident light.

“Dipole moment” refers to a measure of a separation of positive and negative electrical charges within materials.

“Sensitivity to light” refers to a property of materials that when exposed to photons typically within a visible region, such as of about 400 nm to about 750 nm, LSPR may be excited.

### DESCRIPTION OF THE DRAWINGS

The present disclosure relates to a system for splitting water and producing hydrogen for use as an energy source in different applications. The water splitting system may employ a plasmon-induced enhancement of catalytic properties of semiconductor photocatalysts, in which photocatalytic capped colloidal nanocrystals (PCCN) may be deposited between plasmonic nanoparticles within a photoactive material. The plasmonic metal nanoparticles may react to incident light to create a very intense electric field between two adjacent plasmonic metal nanoparticles, initiated by surface plasmon resonance. These intense electric fields may enhance the production of charge carriers by the plasmonic nanoparticles for use in redox reactions necessary for photocatalytic water splitting to occur, and may also improve the catalytic properties of the PCCN.

Both the plasmonic metal nanoparticles and the PCCN may first be produced separately and subsequently combined, deposited on a substrate, and thermally treated for forming the photoactive material.

Photoactive Material Formation

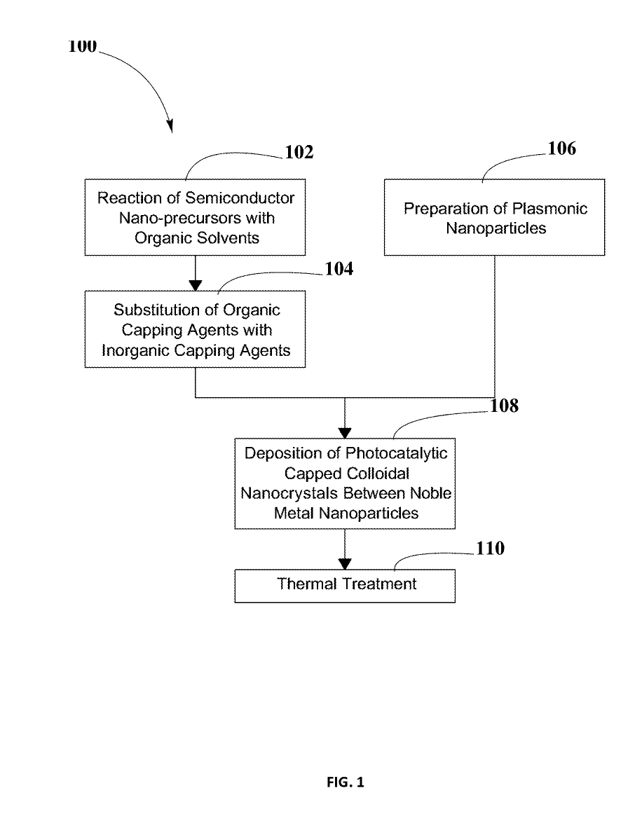

FIG. 1 is a flow diagram for a method for forming a photoactive material 100. To form a composition of PCCN that may be included in the photoactive material, semiconductor nanocrystals may first be formed, for which known synthesis techniques via batch or continuous flow wet chemistry processes may be employed. These known techniques may include a reaction of semiconductor nano-precursors with organic solvents 102, which may involve capping semiconductor nanocrystal precursors in a stabilizing organic material, or organic ligands, referred to in this description as an organic capping agent, for preventing agglomeration of the semiconductor nanocrystals during and after reaction of semiconductor nano-precursors with organic solvents 102. Additionally, the long organic chains radiating from organic capping agents on the surface of semiconductor nanocrystals may assist in suspending or dissolving those nanocrystals in a solvent. One example of an organic capping agent may be trioctylphosphine oxide (TOPO), which may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after their synthesis. Suitable organic capping agents may also include long-chain aliphatic amines, long-chain aliphatic phosphines, long-chain aliphatic carboxylic acids, long-chain aliphatic phosphonic acids and mixtures thereof.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties or charge carrier mobility. As known in the art, a number of synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be used.

Examples of semiconductor nanocrystals may include the following: AlN, AlP, AIAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures thereof. Additionally, examples of applicable semiconductor nanocrystals may further include core/shell semiconductor nanocrystals such as Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O₄, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods such as CdSe; core/shell nanorods such as CdSe/CdS; nano-tetrapods such as CdTe, and core/shell nano-tetrapods such as CdSe/CdS.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, and tetrahedra (tetrapods), among others. Neither the morphology nor the size of semiconductor nanocrystals may inhibit method for forming a photoactive material 100; rather, the selection of morphology and size of semiconductor nanocrystals may permit the tuning and control of the properties of PCCN. The semiconductor nanocrystals may have a diameter between about 1 nm and about 1000 nm, although typically they are in the 2 nm-10 nm range. Due to the small size of the semiconductor nanoparticles, quantum confinement effects may manifest, resulting in size, shape, and compositionally dependent optical and electronic properties, versus properties for the same materials in bulk scale.

Following reaction of semiconductor nano-precursors with organic solvents 102, a substitution of organic capping agents with inorganic capping agents 104 may take place. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction may rapidly produce insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystals, and inorganic capping agents may bind to that semiconductor nanocrystal surface. This process may continue until an equilibrium is established between inorganic capping agents and the free inorganic capping agents. Preferably, the equilibrium favors inorganic capping agents. All the steps described above may be carried out in a nitrogen environment inside a glove box.

The purification of inorganic capped semiconductor nanocrystals may require an isolation procedure, such as the precipitation of inorganic product. That precipitation permits one of ordinary skill to wash impurities and/or unreacted materials out of the precipitate. Such isolation may allow for the selective application of PCCN.

Preferred inorganic capping agents for PCCN may include polyoxometalates and oxometalates, such as tungsten oxide, iron oxide, gallium zinc nitride oxide, bismuth vanadium oxide, zinc oxide, titanium dioxide, among others.

Inorganic capping agents may include metals selected from transition metals. Additionally, inorganic capping agent may be ZintI ions. As used in the present disclosure, ZintI ions may refer to homopolyatomic anions and heteropolyatomic anions that may have intermetallic bonds between the same or different metals of the main group, transition metals, lanthanides, and/or actinides. Examples of ZintI ions may include: As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi 33-, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻Sb₄²⁻, Sb₂³⁻, SbSe₄³⁻, SbSe₄⁵⁻, SbTe₄⁵⁻, Sb₂Se₃⁻, Sb₂Te₅⁴⁻, Sb₂Te₇⁴⁻,Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, Sn S₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TITe₂²⁻, and mixed metal SnS₄Mn₂⁵⁻, among others. The positively charged counter ions may be alkali metal ions, ammonium, hydrazinium, tetraalkylammonium, among others.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Still further, inorganic capping agents may include mixtures of ZintI ions and molecular compounds.

These inorganic capping agents further may include transition metal chalcogenides, examples of which may include the tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, such as MoS(Se₄)₂²⁻, Mo₂S₆²⁻, among others.

Method for forming a photoactive material 100 may be adapted to produce a wide variety of PCCN. Adaptations of this method for forming a photoactive material 100 may include adding two different inorganic capping agents to a single semiconductor nanocrystals (e.g., Au.(Sn₂S₆;In₂Se₄); Cu₂Se.(In₂Se₄;Ga₂Se₃)), adding two different semiconductor nanocrystals to a single inorganic capping agent (e.g., (Au;CdSe).Sn₂S₆; (Cu₂Se;ZnS).Sn₂S₆), adding two different semiconductor nanocrystals to two different inorganic capping agents (e.g., (Au;CdSe).(Sn₂S₆;In₂Se₄)), and/or additional multiplicities.

The sequential addition of inorganic capping agents to semiconductor nanocrystals may be possible under the disclosed method for forming a photoactive material 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable PCCN may include Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄ Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

As used in the present disclosure, the denotation Au.Sn₂S₆ may refer to an Au semiconductor nanocrystal capped with a Sn₂S₆ inorganic capping agent. Charges on the inorganic capping agent are omitted for clarity. This notation [semiconductor nanocrystal]. [inorganic capping agent] is used throughout this description. The specific percentages of semiconductor nanocrystals and inorganic capping agents may vary between different types of PCCN.

Preparation of plasmonic nanoparticles 106 may be a process performed separately from reaction of semiconductor nano-precursors with organic solvents 102. According to various embodiments of the present disclosure, different methods known in the art for preparation of plasmonic nanoparticles 106 may be employed, which may vary according to the different materials and desired shapes of the noble metal nanoparticles to be used, reaction times, temperatures, and other factors. Nanoparticles of noble metals, such as Ag, Au, and Pt, may be used in preparation of plasmonic nanoparticles 106 because noble metal nanoparticles are capable of absorbing visible light due to their localized surface plasmon resonance, which may be tuned by varying their size, shape, and surrounding of the noble metal nanoparticles. Furthermore, noble metal nanoparticles may also work as an electron trap and active reaction sites, which may be beneficial in the use for photocatalytic reactions used for water splitting.

Plasmonic nanoparticles may include any suitable shape, but generally shapes employed may include spherical (nanospheres), cubic (nanocubes), or wire (nanowires), among others. The shapes of these plasmonic nanoparticles may be obtained by various synthesis methods. For example, Ag plasmonic nanoparticles of various shapes may be formed by the reduction of silver nitrate with ethylene glycol in the presence of poly(vinyl pyrrolidone) (“PVP”). Ag nanocubes may be obtained by adding silver nitrate in ethylene glycol at a concentration of about 0.25 mol/dm3 and PVP in ethylene glycol at a concentration of about 0.375 mol/dm3 to heated etheylene glycol and allowing the reaction to proceed at a reaction temperature of about 160° C. The injection time may be of about 8 min, the unit of volume may be of about one milliliter (mL), and the reaction time may be of about 45 minutes.

According to embodiments of the present disclosure, approaches for preparation of plasmonic nanoparticles 106 may include depositing noble metal nanoparticles on the surface of a suitable polar semiconductor, such as AgCl, N—TiO₂ or AgBr, to form a metal-semiconductor composite plasmonic nanoparticle photocatalyst. In this embodiment, the noble metal nanoparticles may strongly absorb visible light, and the photogenerated electrons and holes of the noble metal nanoparticles may be efficiently separated by the metal-semiconductor interface.

As another example embodiment, a procedure for obtaining Au plasmonic nanoparticles embedded in SiO₂/TiO₂ thin films is described, where Au may function as the noble metal nanoparticle and SiO₂/TiO₂ as the semiconductors included in the plasmonic nanoparticles. In this embodiment, Au plasmonic nanoparticles may first be deposited onto a substrate, and the PCCN may be deposited subsequently. Initially, an ethanolic solution of the SiO₂/TiO₂ precursor and poloxamer (e.g. PluronicP123-poly(ethylene oxide)-poly(propylene oxide)-poly(ethyleneoxide) (PEO-PPO-PEO) triblock copolymer) may be spin coated onto a Si or glass substrate. Then, a solution of HAuCl₄ may be deposited dropwise onto the surface and the sample may be spun again. Finally, the resulting film may be baked at about 350° C. for about 5 min. During the bake, a significant color change may take place because of the incorporation of Au nanoparticles in the host matrix.

The formation of inorganic matrices between the Au nanoparticle and the SiO₂/TiO₂ may be based on the acid-catalysed hydrolytic polycondensation of metal alkoxides such as tetraethyl orthosilicate (SiO₂ precursor) and titanium tetrai-sopropoxide (TTIP; TiO₂ precursor) in the presence of poloxamer, which may be used to achieve homogeneous, mesoporous spin-coated thin films. Moreover, the poloxamer may play a key role on the incorporation of the AuCl₄— ions (Au nanoparticle precursor) into the host matrix because the PEO in poloxamer may form cavities (pseudo-crownethers) that may efficiently bind metal ions. Furthermore, the PEO and PPO blocks in poloxamer may act as reducing agents of AuCl₄ for the in situ synthesis of Au nanoparticles. Additionally, the formation of ethanol and isopropanol as byproducts of the respective TEOS (tetraethylorthosilicate, Si(OCH₂CH₃)₄ and TTIP polycondensations may also facilitate the reduction of Au(III).

The nanocomposite thin film formed by the above described method may have a surface roughness of about 10 to about 30 nm, depending on the size of Au nanoparticles produced in the metal oxide matrix, which may be determined by the concentration of Au(III) in the precursor solution.

After preparation of plasmonic nanoparticles 106, a deposition of PCCN between plasmonic nanoparticles 108 may take place. According to an embodiment, deposition of PCCN between plasmonic nanoparticles 108 may include first depositing plasmonic nanoparticles over a substrate, and then depositing the composition of PCCN over the substrate. According to another embodiment, PCCN may first be deposited over the substrate, followed by the deposition of PCCN over the substrate. According to yet another embodiment, both the composition of plasmonic nanoparticles and the composition of PCCN may be mixed and deposited over the substrate. Deposition methods over substrates may include spraying deposition, sputter deposition, electrostatic deposition, spin coating, inkjet deposition, and laser printing (matrices), among others.

According to various embodiments of the present disclosure, suitable substrates that may be used in the present disclosure may include non-porous substrates and porous substrates, which may additionally be optically transparent in order to allow plasmonic nanoparticles and PCCN to receive more light. Suitable non-porous substrates may include polydiallyldimethylammonium chloride (PDDA), polyethylene terephthalate (PET), and silicon, while suitable porous substrates may include glass frits, fiberglass cloth, porous alumina, and porous silicon. Suitable porous substrates may additionally exhibit a pore size sufficient for gas to pass through at a constant flow rate, in cases in which vapor water may be used for the water splitting process. Suitable substrates may be planar or parabolic, individually controlled planar plates, or a grid work of plates.

After both plasmonic nanoparticles and PCCN have been deposited over the substrate, a thermal treatment 110 may take place, which may result in the formation of a photoactive material for use in photoacatalytic reactions. Many of the inorganic capping agents used in PCCN may be precursors to inorganic materials (matrices), thus a low-temperature thermal treatment 110 of the inorganic capping agents employing a convection heater may provide a gentle method to produce crystalline films including both PCCN and plasmonic nanoparticles. Thermal treatment 110 may yield, for example, ordered arrays of semiconductor nanocrystals within an inorganic matrix, hetero-alloys, or alloys. In at least one embodiment, the convection heater may reach temperatures less than about 350, 300, 250, 200, and/or 180° C.

Plasmonic Nanoparticles and PCCN Alignment

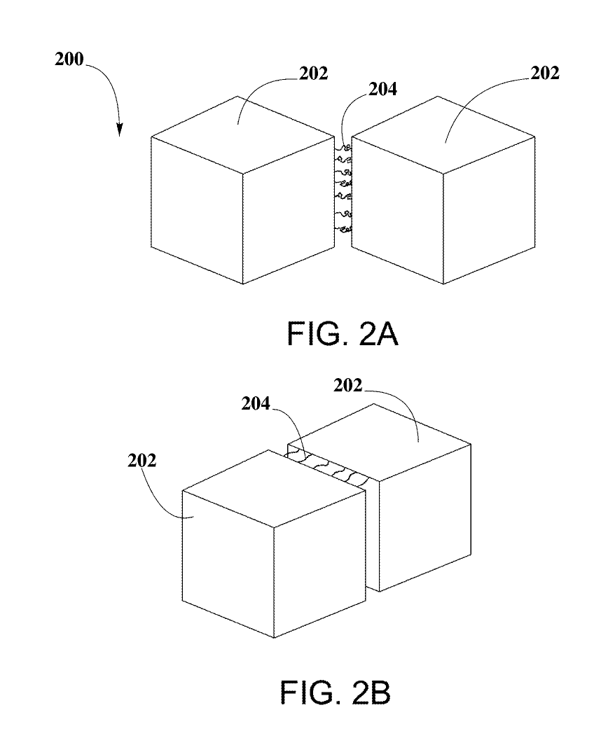

FIGS. 2A and 2B illustrate embodiments of alignment of plasmonic nanoparticles 200 within the photoactive material.

FIG. 2A shows plasmonic nanoparticles 202 in cubic shape exhibiting an edge-to-edge nanojunction employing ligands 204. In FIG. 2B, plasmonic nanoparticles 202 in cubic shape exhibit a face-to-face orientation, also employing ligands 204.

Benefits of using cubic shaped plasmonic nanoparticles 202 may include that cubes may be a compelling geometry for constructing non-close-packed nanoparticle architectures by coordination through facet, corner, or edge sites, and that this shape may support the excitation of higher-order surface plasmon modes occurring through charge localization into the corners and edges of the plasmonic nanoparticles 202. This excitation may enable orientation-dependent electromagnetic coupling between neighboring plasmonic nanoparticles 202, where interparticle junctions formed by cube corners and edges may produce intense electromagnetic fields.

Different methods may be used to align plasmonic nanoparticles 202 in the desired manner. For example, to achieve an edge-to-edge nanojunction, cubic plasmonic nanoparticles 202 may be grafted with a long, floppy polymer ligand such as poly(vinyl pyrrolidone) (PVP, Mw ¼ 55,000) and embedded within a polystyrene (Mw ¼ 10,900) thin film with a thickness of about 150 nm. As the film is annealed using thermal or solvent vapor treatment, plasmonic nanoparticles 202 may assemble in the edge-to-edge nanojunction to form strings that may continuously grow and converge.

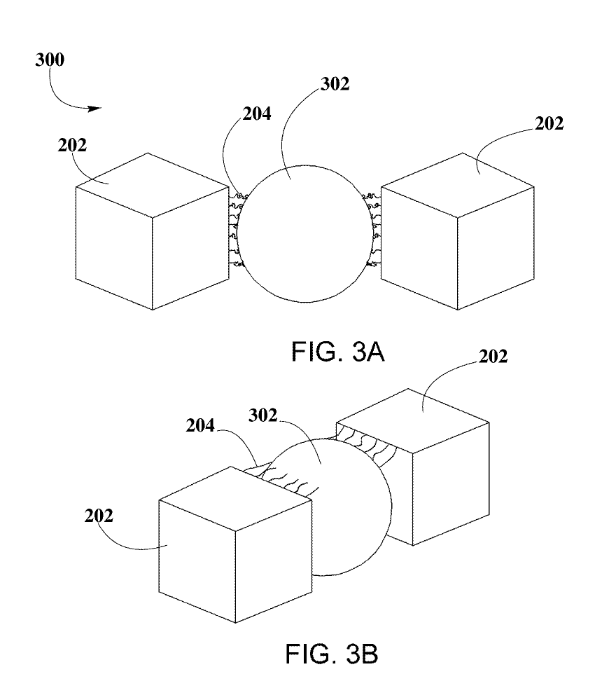

FIGS. 3A and 3B show different embodiments for positioning of PCCN between plasmonic nanoparticles 300 within the photoactive material.

FIG. 3A shows PCCN 302 in spherical shape positioned between plasmonic nanoparticles 202 in edge-to-edge nanojunction employing ligands 204. FIG. 3B shows PCCN 302 positioned between plasmonic nanoparticles 202 in face-to-face nanojunction employing ligands 204. Other arrangements, shapes, and different sizes and elements may be considered when depositing PCCN 302 between plasmonic nanoparticles 202. Additionally, methods other than binding PCCN 302 to plasmonic nanoparticles 202 with ligands 204 may be employed, such as depositing PCCN 302 at stoichiometrically higher ratios so that statistics guides their chances of appropriate orientation.

Ligands 204 may be self-organizing molecules. For example, ligands 204 may be generated using self-assembling monolayer components. Typically, complementary binding pairs employed in ligands 204 are molecules having a molecular recognition functionality. For example, ligands 204 may include an amine-containing compound and a ketone or alcohol-containing compound.

Ligands 204 may be associated, either directly or indirectly, with any of a number of suitable nanostructure shapes and sizes, such as spherical, ovoid, elongated, or branched structures. Ligands 204 may either be directly associated with the surface of a nanostructure, or indirectly associated, through a surface ligand on the nanostructure; this interaction may be, for example, an ionic interaction, a covalent interaction, a hydrogen bond interaction, an electrostatic interaction, a coulombic interaction, a van der Waals force interaction, or a combination thereof. Optionally, the chemical composition of ligands 204 may include one or more functionalized head groups capable of binding to a nanostructure surface, or to an intervening surface ligand. Chemical functionalities that may be used as a functionalized head group may include one or more phosphonic acid, carboxylic acid, amine, phosphine, phosphine oxide, carbamate, urea, pyridine, isocyanate, amide, nitro, pyrimidine, imidazole, salen, dithiolene, catechol, N,O-chelate ligand (such as ethanol amine or aniline phosphinate), P,N-chelate ligand, and/or thiol moieties.

Localized Surface Plasmon Resonance (LSPR)

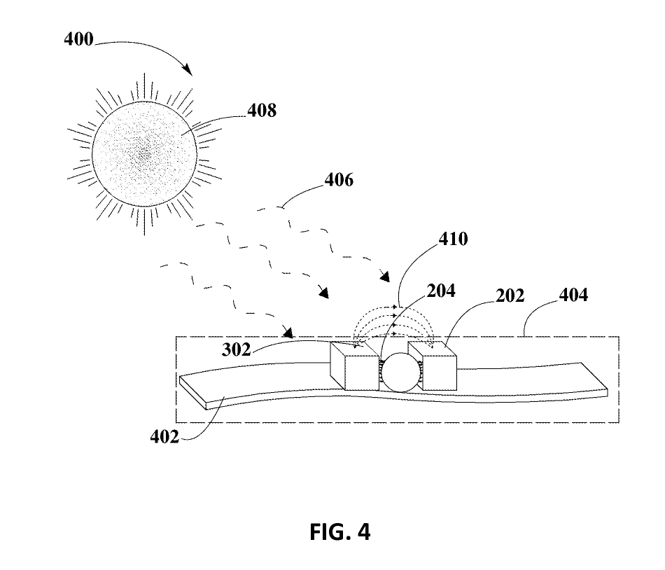

FIG. 4 shows LSPR of photoactive material 400. Accordingly, PCCN 302 may be located between plasmonic nanoparticles 202 deposited over a substrate 402 for forming a photoactive material 404.

When light 406 emitted from a light source 408 makes contact with plasmonic nanoparticles 202, oscillations of free electrons may occur as a consequence of the formation of a dipole moment in plasmonic nanoparticles 202 due to action of energy from electromagnetic waves of incident light 406. The electrons may migrate in plasmonic nanoparticles 202 to restore plasmonic nanoparticles 202 initial electrical state. However, light waves may constantly oscillate, leading to a constant shift in the dipole moment of plasmonic nanoparticles 202, thus electrons may be forced to oscillate at the same frequency as light 406, a process known as LSPR.

LSPR may only occur when frequency of light 406 is equal to or less than frequency of surface electrons oscillating against the restoring force of positive nuclei within plasmonic nanoparticles 202. LSPR may be considered greatest at the electron plasma frequency of plasmonic nanoparticles 202, which is referred to as the resonant frequency. In plasmonic nanoparticles 202, the resonant frequency may be tuned by changing the geometry and size of plasmonic nanoparticles 202. The intensity of resonant electromagnetic radiation may be enhanced by several orders of magnitude near the surface of plasmonic nanoparticles 202. Additionally, LSPR of photoactive material 400 may create strong electric fields 410 between plasmonic nanoparticles 202. These electric fields 410 may closely interact with each other in adjacent plasmonic nanoparticles 202, which may increase formation of charge carriers for use in redox reactions for photocatalytic processes and enhance efficiency of these photocatalytic reactions.

Intensity of LSPR and electric field 410 may depend on wavelength of light 406 employed, as well as on materials, shapes, and sizes of plasmonic nanoparticles 202. These properties may be related to the densities of free electrons in the noble metals within plasmonic nanoparticles 202. Suitable materials used for plasmonic nanoparticles 202 may include those that are sensitive to visible light 406, although, according to other embodiments and depending on the wavelength of light 406, materials that are insensitive to visible light 406 may also be employed.

For example, the densities of free electrons in Au and Ag nanoparticles may be considered to be in the proper range to produce LSPR peaks in the visible part of the optical spectrum. For spherical gold and silver nanoparticles of about 1 to about 20 nm in diameter, only dipole plasmon resonance may be involved, displaying a strong LSPR peak of about 510 nm and about 400 nm, respectively.

According to various embodiments of the present disclosure, any suitable light source 408 may be employed to provide light 406. A suitable light source 408 may be sunlight, which includes infrared light, ultraviolet light, and visible light. Sunlight may be diffuse, direct, or both. Light 406 may be filtered or unfiltered, modulated or unmodulated, attenuated or unattenuated. Light 406 may also be concentrated to increase the intensity using a light intensifier (not shown in FIG. 4), which may include any combination of lenses, mirrors, waveguides, or other optical devices. The increase in the intensity of light 406 may be characterized by the intensity of light 406 having from about 300 to about 1500 nm (e.g., from about 300 nm to about 800 nm) in wavelength. A light intensifier may increase the intensity of light 406 by any factor, preferably by a factor greater than about 2, more preferably a factor greater than about 10, and most preferably a factor greater than about 25.

Plasmonic Photocatalysis

According to an embodiment, photoactive material 404 may be submerged in water for redox reactions to occur that may result in the separation of hydrogen and oxygen molecules. Produced hydrogen may be stored to be later used as a fuel source.

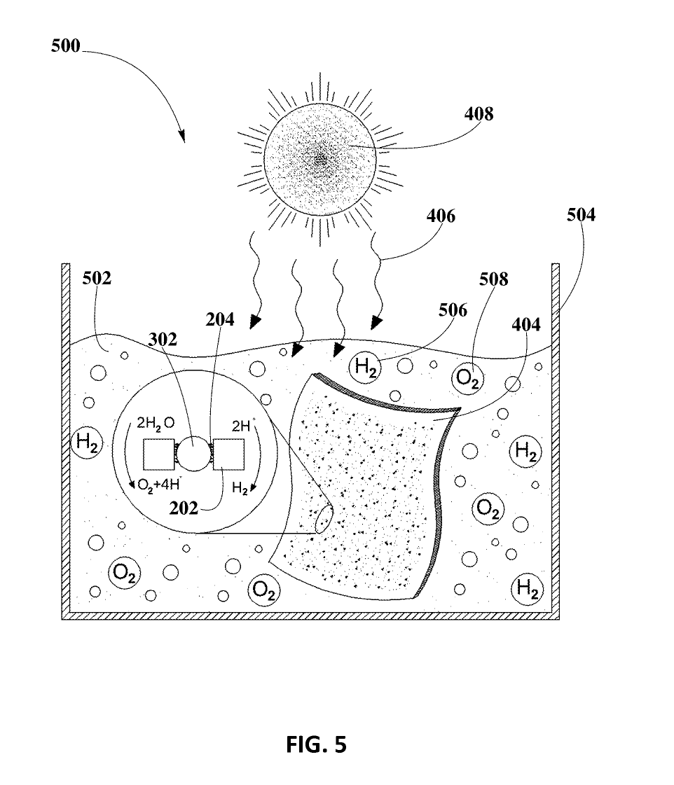

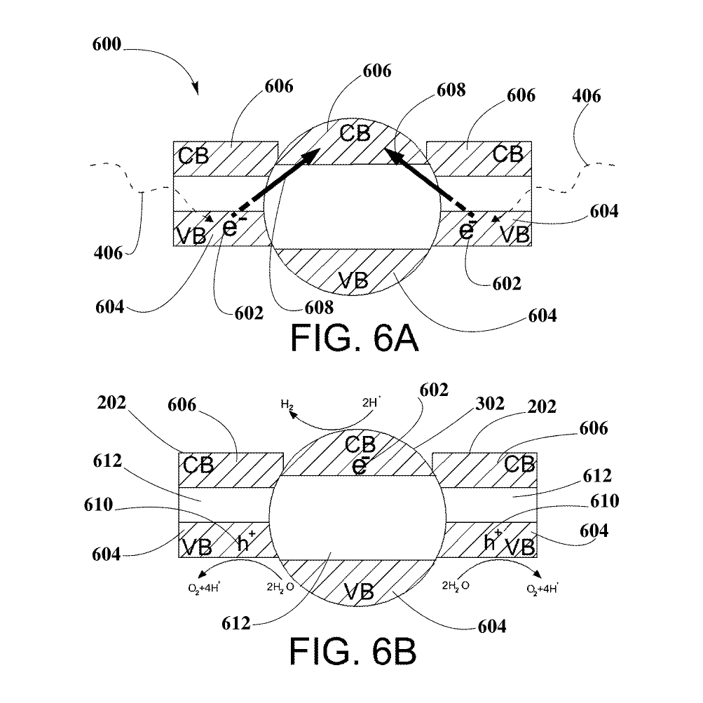

FIG. 5 shows water splitting 500 in which photoactive material 404 may be submerged in water 502 within a reaction vessel 504. When light 406 from light source 408 makes contact with plasmonic nanoparticles 202 within photoactive material 404, redox reactions may take place in which a charge separation process may occur (explained in FIG. 6). This charge separation may result in electrons reducing hydrogen molecules 506 and oxygen molecules 508 being oxidized by holes.

According to various embodiments, one or more walls of reaction vessel 504 may be formed of glass or other transparent material, so that light 406 may enter reaction vessel 504. It is also possible that most or all of the walls of reaction vessel 504 are transparent such that light 406 may enter from many directions. In another embodiment, reaction vessel 504 may have one side which is transparent to allow the incident radiation to enter and the other sides may have a reflective interior surface for reflecting the majority of the solar radiation.

FIGS. 6A and 6B show charge separation 600 that may occur during water splitting 500.

In FIG. 6A, when light 406 with a frequency that is equal to or less than frequency of surface electrons 602 oscillating against the restoring force of positive nuclei within plasmonic nanoparticles 202, and with energy equal to or greater than that of band gap 612 of plasmonic nanoparticles 202, makes contact with plasmonic nanoparticles 202, electrons 602 may be excited and may migrate from valence band 604 of plasmonic nanoparticles 202 to conduction band 606 of PCCN 302. This process may be triggered by photo-excitation 608 and enhanced by the rapid electron 602 resonance from LSPR.

In FIG. 6B, when electrons 602 are in conduction band 606 of PCCN 302, electrons 602 may reduce hydrogen molecules 506 from water 502, while oxygen molecules 508 may be oxidized by holes 610 left behind in valence band 604 of plasmonic nanoparticles 202. Accordingly, in order for water splitting 500 to take place, photo-excited electrons 602 from plasmonic nanoparticles 202 may need to have a reduction potential greater than or equal to that necessary to drive the following reaction:

2H₃O⁺+2e⁻→H₂+2H2O (1)

This reaction has a standard reduction potential of 0.0 eV vs. the standard hydrogen electrode (SHE), or standard hydrogen potential of 0.0 eV. Hydrogen molecules 506 (H₂) in water 502 may be reduced when receiving two electrons 602. On the other hand, holes 610 should have an oxidation potential greater than or equal to that necessary to drive the following reaction:

6H₂O+4h⁺→O₂+4H₃O⁺ (2)

That reaction may exhibit a standard oxidation potential of −1.23 eV vs. SHE. Oxygen molecules 508 (O₂) in water 502 may be oxidized by four holes 610. Therefore, the minimum band gap 612 for plasmonic nanoparticles 202 in water splitting 500 is 1.23 eV. Given overpotentials and loss of energy for transferring the charges to donor and acceptor states, the minimum energy may be closer to 2.1 eV.

Electrons 602 may acquire energy corresponding to the wavelength of the absorbed light 406. Upon being excited, electrons 602 may relax to the bottom of conduction band 606, which may lead to recombination with holes 610 and therefore to an inefficient process for water splitting 500. For an efficient charge separation 600, reactions have to take place to quickly sequester and hold electrons 602 and holes 610 for use in subsequent redox reactions used for water splitting 500. For this purpose, the combined use of plasmonic nanoparticles 202 with enhanced electric fields 410 and LSPR, and the use of efficient PCCN 302 for accelerating redox reactions, may prevent recombination of charge carriers and may lead to an enhanced water splitting 500.

Band gap 612 of energy of plasmonic nanoparticles 202 and PCCN 302 may be strongly size-and-shape dependent since these effects may determine absolute positions of the energy quantum-confined states in both plasmonic nanoparticles 202 and PCCN 302. The ability to efficiently inject or extract charge carriers may depend on the energy barriers that form at the interfaces between individual plasmonic nanoparticles 202 and also at the interface between PCCN 302 and plasmonic nanoparticles 202. If contacts do not properly align, a potential barrier may form, leading to poor charge injection and nonohmic contacts.

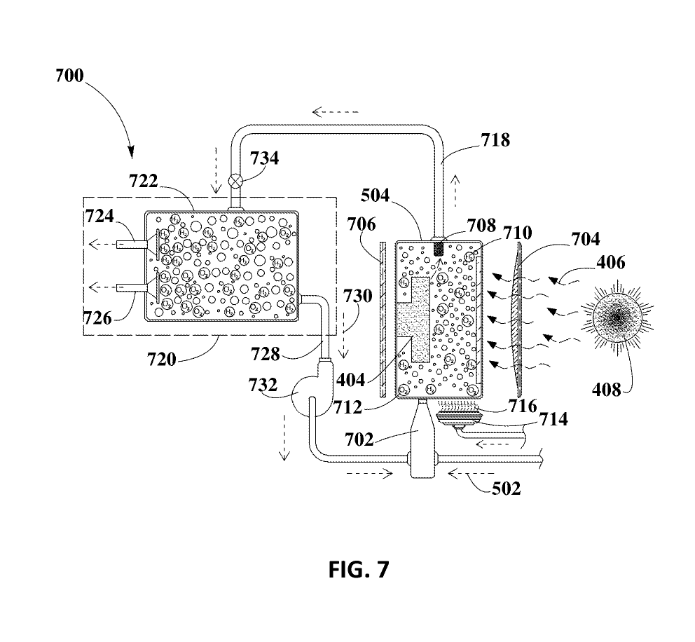

FIG. 7 shows a water splitting system 700 employing water splitting 500.

A continuous flow of water 502 as gas or liquid may enter reaction vessel 504 through a nozzle 702. Subsequently, water 502 may pass through a region including photoactive material 404 illuminated by light 406 emitted by light source 408 for water splitting 500 occur. Water splitting system 700 may additionally include a light intensifier 704 for concentrating light 406 and increasing efficiency of water splitting 500, and a solar reflector 706 for reflecting as much light 406 as possible to reaction vessel 504. Subsequently, water 502 may exit through a filter 708. Water 502 coming through nozzle 702 may also include hydrogen gas 710, oxygen gas 712 and other gases such as an inert gas or air. According to an embodiment, water 502 entering reaction vessel 504 may include recirculated gas removed from reaction vessel 504 and residual water 502 which did not react in reaction vessel 504 along with hydrogen gas 710 and oxygen gas 712, as well as any other gas in water splitting system 700. Preferably, a heater 714 may be connected to reaction vessel 504 to produce heat 716 so that water 502 may boil, assisting on the extraction of hydrogen gas 710 and oxygen gas 712 through filter 708. Heater 714 may be powered by different energy supplying devices. Preferably, heater 714 may be powered by renewable energy supplying devices, such as photovoltaic cells, or by energy stored employing the system and method from the present disclosure. Materials for the walls of reaction vessel 504 may be selected based on the reaction temperature.

Filter 708 may allow the exhaust of water 502 from reaction vessel 504 while trapping certain impurities from water 502. Filter 708 may permit the passage of hydrogen gas 710, oxygen gas 712, and water 502 which may subsequently flow through exhaust tube 718.

After passing through reaction vessel 504, water 502, hydrogen gas 710, and oxygen gas 712 may be transferred through exhaust tube 718 to a collector 720 which may include a reservoir 722 connected to a hydrogen permeable membrane 724 (e.g. silica membrane) and an oxygen permeable membrane 726 (e.g. silanized alumina membrane) for collecting hydrogen gas 710 and oxygen gas 712 to be stored in tanks or any other suitable storage equipment. Collector 720 may also be connected to a recirculation tube 728 which may transport remaining exhaust gas 730 back to nozzle 702 to supply additional water 502 to reaction vessel 504. Additionally, remaining exhaust gas 730 may be used to heat water 502 entering nozzle 702. The flow of hydrogen gas 710, oxygen gas 712 and water 502 in water splitting system 700 may be controlled by one or more pumps 732, valves 734, or other flow regulators.

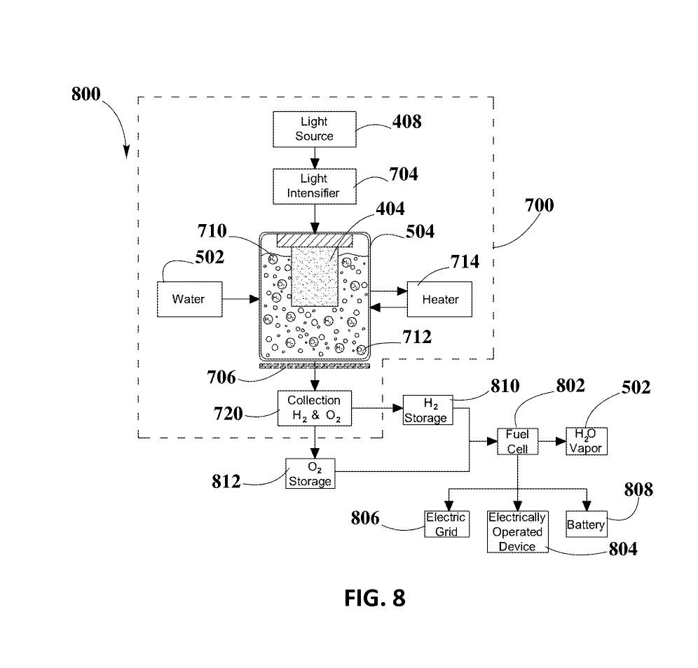

FIG. 8 depicts energy generation system 800 that may be used to generate and store hydrogen gas 710 and oxygen gas 712 for use in a hydrogen fuel cell 802, generating electricity that may be employed in one or more electrically driven applications 804, electric grids 806, batteries 808, among others.

Hydrogen gas 710 and oxygen gas 712 resulting from water splitting system 700 may be stored in hydrogen storage 810 and oxygen storage 812. Hydrogen gas 710 and oxygen gas 712 may then be collected in a collector 720 and combined in a hydrogen fuel cell 802 that may produce water 502 vapor or liquid and electricity, the latter of which may be provided to an electric grid 806, used in an electrically driven application 804 (e.g. a motor, light, heater, pump, amongst others), stored in a battery 808, or any combination thereof.

According to another embodiment, electricity may be produced by burning hydrogen gas 710 to produce steam and then generating electricity using a steam Rankine cycle-generator set.

Energy generation system 800 may be mounted on a structure such as the roof of a building, or may be free standing, such as in a field. Energy generation system 800 may be stationary, or may be on a mobile structure (e.g. a transportation vehicle, such as a boat, an automotive vehicle, and farming machinery). The mounting of energy generation system 800 may include elements for adjusting the positioning of reaction vessel 504, light intensifier 704 or both, such that the intensity of intensified light 406 in reaction vessel 504 may be increased. For example, light intensifier 704 may be adjusted to track the position sunlight. Such adjustments to the position of light intensifier 704 may be made to accommodate seasonal or daily positioning of the sun. The adjustments may be made frequently throughout the day.

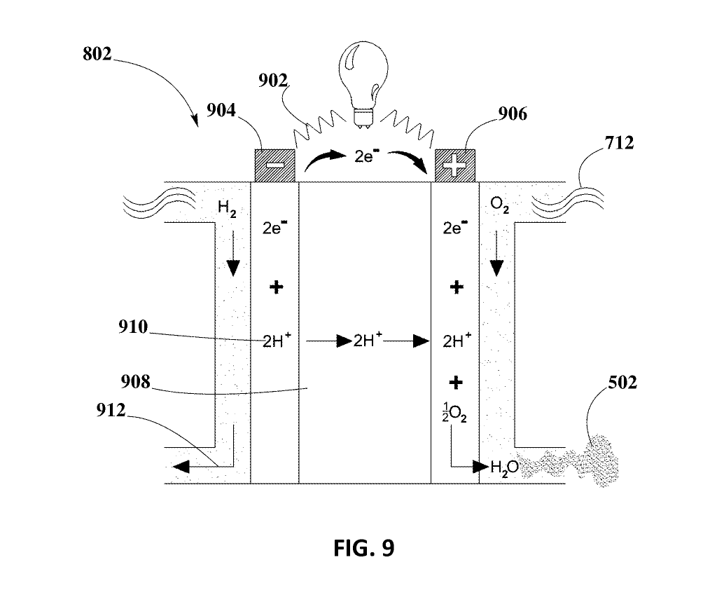

FIG. 9 depicts a hydrogen fuel cell 802 that may be used for mixing hydrogen gas 710 and oxygen gas 712 for the production of electricity 902 and water 502. Hydrogen fuel cell 802 may include two electrodes, an anode 904 making contact with hydrogen gas 710, and a cathode 906 making contact with oxygen gas 712, separated by an electrolyte 908 that may allow charges to move between both sides of hydrogen fuel cell 802. Electrolyte 908 is electrically insulating, specifically designed so protons 910 (H⁺) may pass through, but electrons 602 (e−) may not.

At anode 904, a catalyst oxidizes incoming hydrogen gas 710, forming hydrogen protons 910 and electrons 602. Hydrogen gas 710 that has not reacted with the catalyst in anode 904 may leave hydrogen fuel cell 802 via hydrogen exhaust 912. Freed electrons 602 may travel through a conductor such as a wire (not shown) creating electricity 902 that may be used to power electrically driven applications 804, while protons 910 may travel through electrolyte 908 to cathode 906. Once reaching cathode 906, hydrogen protons 910 may reunite with electrons 602, subsequently reacting and combining with oxygen gas 712, to produce water 502.

While various aspects and embodiments have been disclosed, other aspects and embodiments are contemplated. The various aspects and embodiments disclosed are for purposes of illustration and are not intended to be limiting, with the true scope and spirit being indicated by the following claims.

### EXAMPLES

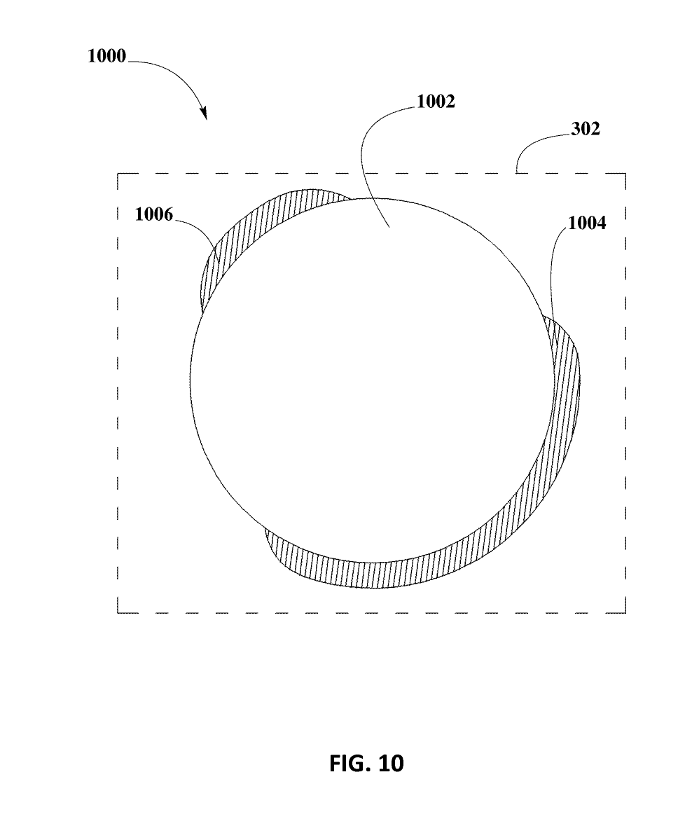

Example #1 is an embodiment of PCCN 302 in spherical shape 1000, as shown in FIG. 10, which may include a single semiconductor nanocrystal 1002 capped with a first inorganic capping agent 1004 and a second inorganic capping agent 1006.

In an embodiment, single semiconductor nanocrystal 1002 may be PbS quantum dots, with SnTe₄⁴⁻ used as first inorganic capping agent 1004 and AsS₃³⁻ used as second inorganic capping agent 1006, therefore forming a PCCN 302 represented as PbS.(SnTe₄;AsS₃).

The shape of semiconductor nanocrystals 1002 may improve photocatalytic activity of semiconductor nanocrystals 1002. Changes in shape may expose different facets as reaction sites and may change the number and geometry of step edges where reactions may preferentially take place.

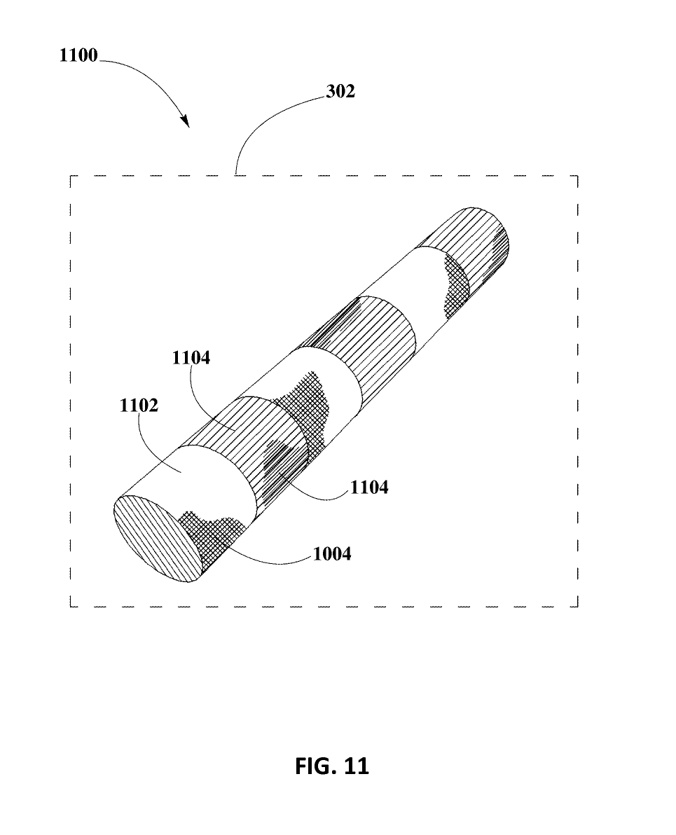

Example #2 is an embodiment of PCCN 302 in nanorod shape 1100, as shown in FIG. 11. According to an embodiment, there may be three CdSe regions and four CdS regions as first semiconductor nanocrystal 1102 and second semiconductor nanocrystal 1104, respectively. In addition, first semiconductor nanocrystal 1102 and second semiconductor nanocrystal 1104 may be capped with first inorganic capping agent 1004 and second inorganic capping agent 1006, respectively. Each of the three CdSe first semiconductor nanocrystal 1102 regions may be longer than each of the four CdS second semiconductor nanocrystal 1104 regions. In other embodiments, the different regions with different materials may have the same or different lengths, and there may be any suitable number of different regions. The number of segments per nanorod in nanorod shape 1100 may generally increase by increasing the length of the nanorod or decreasing the spacing between like segments.

The embodiments described above are intended to be exemplary. One skilled in the art recognizes that numerous alternative components and embodiments that may be substituted for the particular examples described herein and still fall within the scope of the invention.

What's claimed is:

1. A method for water splitting comprising:
forming photocatalytic capped colloidal nanocrystals, wherein each photocatalytic capped colloidal nanocrystal includes a first semiconductor nanocrystal capped with a first inorganic capping agent;
forming plasmonic nanoparticles, wherein the plasmonic nanoparticles include noble metal nanoparticles;
depositing the formed plasmonic nanoparticles onto a substrate;
depositing the formed photocatalytic capped colloidal nanocrystals on the substrate between the plasmonic nanoparticles, wherein each photocatalytic capped colloidal nanocrystal is deposited between at least two plasmonic nanoparticles;
thermally treating the substrate, the photocatalytic capped colloidal nanocrystals, and the plasmonic nanoparticles;
absorbing light with a frequency equal to or greater than a frequency of electrons oscillating against the restoring force of positive nuclei within the plasmonic nanoparticles to cause localized surface plasmon resonance, whereby the localized surface plasmon resonance creates an electric field between two adjacent plasmonic nanoparticles;
absorbing irradiated light with an energy equal to or greater than the band gap of the photocatalytic capped colloidal nanocrystal that causes electrons of the plasmonic nanoparticles to migrate from the valance band of the photocatalytic capped colloidal nanocrystallinto the conduction band of the photocatalytic capped colloidal nanocrystals for use in a reduction reaction, wherein the electric field prevents the electrons from recombining into the valence band of the photocatalytic capped colloidal nanocrystal;
passing water through the reaction vessel so that the water reacts with the photocatalytic capped colloidal nanocrystals and forms hydrogen gas and oxygen gas, wherein the charge carriers in the conduction band reduce hydrogen molecules from the water and holes in the valence band of the photocatalytic capped colloidal nanocrystal oxidize oxygen molecules from the water; and
collecting the hydrogen gas and the oxygen gas in a reservoir that includes a hydrogen permeable membrane and an oxygen permeable membrane.

2. The method of claim 1, wherein forming photocatalytic capped colloidal nanocrystals comprises:
growing semiconductor nanocrystals by employing a template-driven seeded growth method; and
capping the semiconductor nanocrystals with an inorganic capping agent in a polar solvent to form photocatalytic capped colloidal nanocrystals.

3. The method of claim 2, wherein growing semiconductor nanocrystals by employing the template-driven seeded growth method comprises:
depositing a seed crystal on a substrate; and
growing the semiconductor nanocrystal from the seed crystal using molecular beam epitaxy or chemical beam epitaxy so that the semiconductor nanocrystal grows according to the seed crystal's structure.

4. The method of claim 2, wherein capping the semiconductor nanocrystals with an inorganic capping agent in the polar solvent to form the photocatalytic capped colloidal nanocrystals comprises:
reacting semiconductor nanocrystals precursors in the presence of an organic capping agent to form organic capped semiconductor nanocrystals;
reacting the organic capped semiconductor nanocrystals with an inorganic capping agent;
adding immiscible solvents causing the dissolution of the organic capping agents and the inorganic capping agents so that organic caps on the semiconductor nanocrystals are replaced by inorganic caps to form inorganic capped semiconductor nanocrystals; and
performing an isolation procedure to purify the inorganic capped semiconductor nanocrystals and remove the organic capping agent.

5. The method of claim 1, wherein the photocatalytic capped colloidal nanocrystals comprise a compound selected from a group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄ Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

6. The method of claim 1, wherein each photocatalytic capped colloidal nanocrystal includes a second semiconductor nanocrystal capped with a second inorganic capping agent, the first inorganic capping agent acts as a reduction photocatalyst, and the second inorganic capping agent acts as an oxidation photocatalyst.

7. The method of claim 1, wherein forming plasmonic nanoparticles comprises:
reducing silver nitrate with ethylene glycol in the presence of poly(vinyl pyrrolidone) to form silver nanocubes.

8. The method of claim 1, wherein forming plasmonic nanoparticles comprises:
spin coating an ethanolic solution of a SiO₂/TiO₂ precursor and poloxamer onto a Si or glass substrate;
depositing a solution of HAuCl₄ drop wise onto a surface of the Si or glass substrate to form a film; and
baking the film.

9. The method of claim 1, further comprising:
recycling unreacted water by passing the unreacted water in the reservoir back into the reaction vessel.

10. The method of claim 9, further comprising:
filtering the unreacted water, the hydrogen gas, and the oxygen gas leaving the reaction vessel.

11. The method of claim 1, further comprising:
heating the water entering the reaction vessel so that the water boils and is in a gaseous state when reacting with the photocatalytic capped colloidal nanocrystals in the reaction vessel.

12. The method of claim 1, further comprising:
passing the hydrogen gas and the oxygen gas to a fuel cell so that the fuel cell may generate electricity and water.

13. A water splitting system comprising:
a photoactive material comprising:
a substrate;
a plurality of plasmonic nanoparticles deposited on the substrate, wherein the plasmonic nanoparticles create an electric field between two adjacent plasmonic nanoparticles when absorbing light; and
a plurality of photocatalytic capped colloidal nanocrystals deposited on the substrate, wherein each photocatalytic capped colloidal nanocrystal is deposited between at least two plasmonic nanoparticles;
a reaction vessel housing the photoactive material and configured to receive water through a nozzle and facilitate a water splitting reaction when the water reacts with the photocatalytic capped colloidal nanocrystals, wherein the reaction occurs when the photocatalytic capped colloidal nanocrystals and plasmonic nanoparticles absorb irradiated light; and
a collector connected to the reaction vessel and comprising a reservoir that includes a hydrogen permeable membrane and an oxygen permeable membrane for collecting hydrogen gas and oxygen gas.

14. The water splitting system of claim 13, further comprising:
a heater that heats the water entering the reaction vessel so that the water boils and is in a gaseous state when reacting with the photocatalytic capped colloidal nanocrystals in the reaction vessel.

15. The water splitting system of claim 13, further comprising:
a filter that collects impurities from the water.

16. The water splitting system of claim 13, further comprising:
a recirculation tube connected to the collector that transports exhaust gas that was not collected by either the hydrogen permeable membrane or the oxygen permeable membrane back into the reaction vessel.

17. The water splitting system of claim 13, further comprising:
a flow regulator that controls the flow of the water that enters the reaction vessel.

18. The water splitting system of claim 13, further comprising:
a solar reflector positioned within the reaction vessel such that irradiated light that is not absorbed by the photoactive material is reflected back into the reaction vessel.

19. The water splitting system of claim 13, wherein the photocatalytic capped colloidal nanocrystals comprise a first semiconductor nanocrystal capped with a first inorganic capping agent.

20. The water splitting system of claim 19, wherein the photocatalytic capped colloidal nanocrystals further comprise a second semiconductor nanocrystal capped with a second inorganic capping agent.

21. The water splitting system of claim 20, wherein the first inorganic capping agent is a reduction photocatalyst and the second inorganic capping agent is an oxidation photocatalyst.

22. The water splitting system of claim 13, wherein a morphology of the photocatalytic capped colloidal nanocrystals is chosen based on a desired wavelength of the irradiated light usable by the semiconductor nanocrystals.

23. The water splitting system of claim 22, wherein the morphology of the photocatalytic capped colloidal nanocrystals comprise one morphology from a group consisting of a core/shell configuration, a nanowire configuration, or a nanospring configuration.

24. The water splitting system of claim 13, further comprising:
ligands forming a nanojunction between the plasmonic nanoparticles and the photocatalytic capped colloidal nanocrystals.

25. The water splitting system of claim 24, wherein each ligand includes an amine-containing compound and a ketone or alcohol containing compound.

26. The water splitting system of claim 13, wherein the photocatalytic capped colloidal nanocrystals comprise a compound selected from a group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₂, Bi₂Se₃.Sb₂Te₅, Bi₂Se₃.Sb₂Te₂, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

27. The water splitting system of claim 13, wherein the plasmonic nanoparticles include a noble metal.

28. The water splitting system of claim 27, wherein the plasmonic nanoparticles are Au plasmonic nanoparticles, and the Au plasmonic nanoparticles are embedded in SiO₂/TiO₂ thin film.

29. The water splitting system of claim 13, wherein the electric field created between two adjacent plasmonic nanoparticles causes electrons in a valence band of the photocatalytic capped colloidal nanocrystal to migrate to a conduction band of the photocatalytic capped colloidal nanocrystals when light contacts the plasmonic nanoparticles, and the electrons in the conduction band of the photocatalytic capped colloidal nanocrystals are used for a reduction reaction.
